(19) United States
(12) Patent Application Publication
(10) Pub. No.: US 2003/0076428 A1
(43) Pub. Date: Apr. 24, 2003

(54) IMAGE CONVERSION SYSTEM

(76) Inventor: WATURA ITO, KANAGAWA-KEN (JP)

Correspondence Address: BIRCH STEWART KOLASCH & BIRCH, P O BOX 747, FALLS CHURCH, VA, 22040, US

(21) Appl. No.: 09/172,665

(22) Filed: Oct. 15, 1998

(30) Foreign Application Priority Data
Oct. 15, 1997 (JP) 9-281807

(51) Int. Cl. H04N 5/225

(52) U.S. Cl. 348/231.7; 348/222.1

(57) ABSTRACT

In an image conversion system, a film scanner reads out an image on photographic film and generates a digital image signal representing the image. The format of the digital image signal is converted into a predetermined format used in a digital camera, and the digital image signal in the predetermined format is recorded on a recording medium which can be loaded in the digital camera.

### BACKGROUND OF THE INVENTION

1. Field of the Invention

This invention relates to an image conversion system for converting the format of digital image signal in digital photographic service.

2. Description of the Related Art

As personal computers, internets and the like come to be in wide use, there is an increasing trend toward storing a picture as a digital image signal for later use.

In the case of a picture taken by use of photographic film, in order to obtain a digital image representing the picture, the image on the photographic film is read out and an analog image signal obtained is digitized. Recently laboratories and the like provide service to read out images on photographic film of customers, recording digital image signals representing the images on media such as a CD-R and dispense the media to the customers. The customer can edit and/or print the digital images by loading the media in a personal computer.

In such a case, the digital image signal which the laboratory dispenses to the customer is generally made with the intention of making prints from the digital image signal later at the laboratory. Accordingly, such an image signal is generally recorded in an image format at a relatively high resolution suitable for printing such as PhotoCD format or FlashPix format proposed by Eastman Kodak.

To the contrast, in the case of a digital camera, a picture is recorded in a memory as a digital image signal upon taking the picture and there is no necessity of digitizing the image. The user can directly enter the digital image signal recorded in the memory into a personal computer or directly transfer the digital image signal to a digital printer.

The format of the digital image signal recorded in the memory of the digital camera is generally different from the aforesaid PhotoCD or the like since in the case of the digital camera, it is required to store the largest possible number of image signals at a high quality in a memory having a limited capacity. As such a format for a digital camera, there has been known, for instance, Exif format proposed by “Shadan-houjin Nihon Denshi Kougyou Shinkou Kyoukai”. Further there have been known digital cameras in which other nonstandard formats are employed in order to realize a higher image quality and a high compression rate.

There has been known a service to make a seal print by editing and modifying a digital image signal. Such a service is available for both a digital image signal obtained by reading an image on photographic film and a digital image signal taken by a digital camera.

However for the provider of such a service, the digital image signal taken by a digital camera is advantageous over a digital image signal obtained by reading a picture on photographic camera since the former digital image signal does not require, for instance, an image scanner, which less cost the provider. Further when providing a service installing a seal print machine or the like, the cost of the machine can be greatly reduced by limiting the images handled by the machine only to those taken by digital cameras. It is expected that various services and/or systems only for images taken by digital cameras will spread with the spread of digital cameras.

On the other hand, photographic cameras using film is advantageous over digital cameras in that the image quality is higher and the camera is more economical. Especially digital cameras cannot be equal to a so-called film with lens in convenience. Accordingly, it cannot be considered that photographic cameras using film will go out of use as digital cameras spread. That is, the service provider must keep providing the same services also for images recorded on photographic film while reducing the cost by introduction of systems only for images taken by digital cameras.

However in the conventional services and/or systems, pictures recorded on photographic camera cannot enjoy the services unless digital signals representing the pictures are obtained at laboratories and are converted into digital signals in a format for digital cameras by a personal computer.

### SUMMARY OF THE INVENTION

In view of the foregoing observations and description, the primary object of the present invention is to provide an image conversion system which reads out a picture recorded on photographic film and generating an image signal in the same format as an image signal taken by a digital camera, thereby enabling people possessing only a camera using photographic film to enjoy services only for digital cameras.

The image conversion system in accordance with the present invention comprises a digital image generation means which reads out an image on photographic film and generates a digital image signal representing the image, a format conversion means which converts the format of the digital image signal into a predetermined format used in a digital camera, and an image signal recording means which records the digital image signal in the predetermined format on a recording medium which can be loaded in the digital camera.

For example, the digital image generation means may be an image scanner. The predetermined format used in a digital camera may be, for instance, the aforesaid Exif format or the like.

Further the recording medium which can be loaded in the digital camera may be, for instance, a smart medium (SSFDC), a PCMCIA card, a compact flash memory or the like. It may be other various media which have been known or will be developed in the future.

By loading developed film in the image conversion system of the present invention, a digital image signal representing an image on the film which is recorded in a format used in a digital camera on a recording medium which can be loaded in a digital camera. Accordingly, pictures recorded on photographic camera can enjoy services only for digital cameras without use of a personal computer.

This means that even if the service providers limit a part of their services or the objects of handling of their systems to digital cameras only, the customers does not undergo great inconvenience and the providers can reasonably reduce the cost of service by limiting the object of handling to digital cameras only.

Further customers who do not possess a personal computer but possess a digital camera and an ordinary camera can manage both image signals obtained by use of the digital camera and the ordinary camera on the same medium by use of the image conversion system of the present invention.

### BRIEF DESCRIPTION OF THE DRAWING

FIG. 1 is a view showing an image conversion system in accordance with an embodiment of the present invention.

### DESCRIPTION OF THE PREFERRED EMBODIMENT

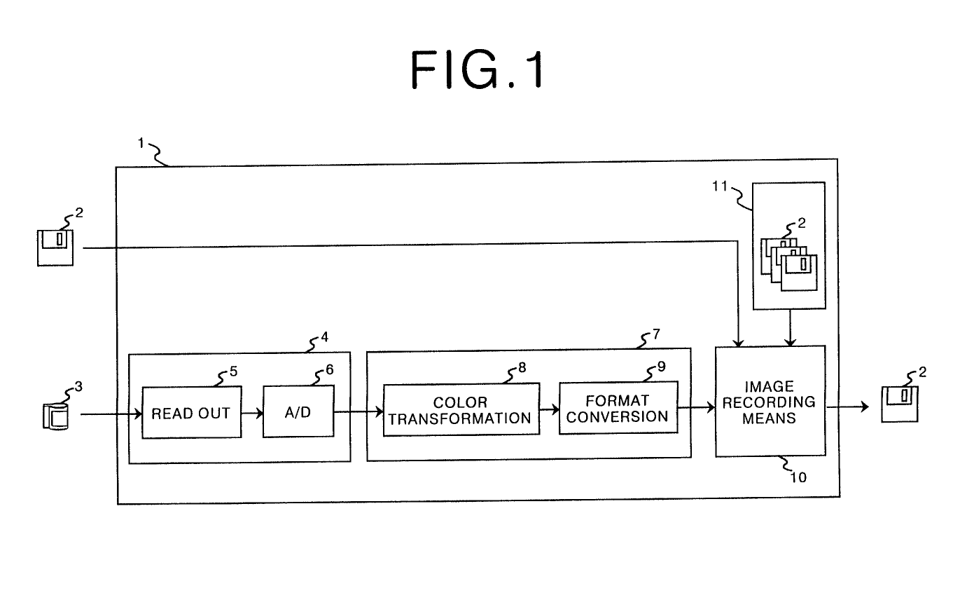

In FIG. 1, an image conversion system 1 in accordance with an embodiment of the present invention comprises a film scanner 4 which reads out an image on developed photographic film 3 and generates a digital image signal representing the image, an image processing means 7 which carries out various image processings on the digital image signal generated by the film scanner 4, an image signal recording means 10 which records the digital image signal processed by the image processing means 7 on a recording medium 2 for digital cameras and a medium storage portion 11 in which virgin recording media 2 are stored.

The image conversion system 1 may be, for instance, in the form of a system comprising a personal computer loaded with exclusive image processing program, a film scanner and a peripheral devices such as a medium drive or in the form of an image conversion unit in which all the functions are incorporated in one housing.

The film scanner 4 is provided with a film set portion. The film set portion may be in such a form that the film is set to the film set portion by itself or the film cassette is set to the film set portion and the film is automatically drawn out from the cassette. Further the film set portion may be in such a form that a film with lens is set to the film set portion and the housing of the film with lens is automatically disassembled and the film is drawn out.

In any cases, a reading portion 5 of the film scanner 4 reads out the image on the film 3 and the analog image signal thus obtained is digitized into a digital image signal by an A/D convertor 6 of the film scanner 4. At this time, the digital image signal is data expressed by a color space of the film scanner.

Then the digital image signal is transformed into a color space of an image taking system of a digital camera by color transformation means 8 of the image processing means 7, whereby an 8-bit digital image signal where each of R, G and B are expressed in 8 bits is obtained. Further the 8-bit digital image signal is converted into a format for digital cameras, e.g. Exif, by a format conversion means 9 of the image processing means 7.

The digital image signal in the converted format is recorded on a recording medium 2 for digital cameras by the image signal recording means 10. When the user sets a recording medium together with the film 3, the image signal recording means 10 records the digital image on the recording medium set by the user, and when the user sets only the film 3, the image signal recording means 10 records the digital image on a recording medium 2 of a designated kind taken out from the medium storage portion 11. Then the recording medium 2 on which the digital image signal is recorded is dispensed to the user.

Various formats for digital cameras other than Exif are proposed by various digital camera makers. Accordingly it is preferred that the image conversion system 1 be arranged so that the user can select a format from a plurality of formats, for instance, displayed on a monitor. In this case, the format conversion means 9 converts the digital image signal into the format selected by the user which is input into the format conversion means 9 by a known means such as a keyboard.

Similarly it is preferred that the image conversion means 1 be arranged so that the recording medium 2 can be selected from a plurality of kinds of recording media such as a smart medium (SSFDC), a PCMCIA card, a compact flash memory and the like. In this case, a plurality of kinds of recording media are stored in the medium storage portion 11 and a recording medium of the kind selected by the user is taken out from the storage portion 11 and the digital image signal is recorded on the recording medium.

On the recording medium 2 dispensed from the image conversion system 1, the digital image signal is recorded in the same form as that obtained by taking a picture by a digital camera. Accordingly the recording medium 2 can be handled by a system such as a seal print machine for only images taken by a digital camera, e.g., a system only for smart media.

When a memory card on a digital camera is set to the image conversion system 1 of this embodiment together with a film with lens, digital image signals representing pictures taken by the film with lens are recorded on the memory card. This permits all the pictures taken to be recorded on one memory card irrespective of photographing means and facilitates management of images.

Thus the image conversion system of the present invention makes it feasible to provide the same services for all the users irrespective of whether they possess a digital camera or whether they possess a personal computer.

What is claimed is:

1. An image conversion system comprising
a digital image generation means which reads out an image on photographic film and generates a digital image signal representing the image,
a format conversion means which converts the format of the digital image signal into a predetermined format used in a digital camera, and
an image signal recording means which records the digital image signal in the predetermined format on a recording medium which can be loaded in the digital camera.
